(19) United States
(12) Patent Application Publication
(10) Pub. No.: US 2005/0247784 A1
(43) Pub. Date: Nov. 10, 2005

(54) Chipcard reader in pc-card format

(76) Inventor: Dieter Klatt, Wulfrath (DE)

Correspondence Address: CANTOR COLBURN, LLP, 55 GRIFFIN ROAD SOUTH, BLOOMFIELD, CT, 06002, US

(21) Appl. No.: 10/517,983

(22) PCT Filed: Jun. 12, 2003
(86) PCT No.: PCT/EP03/06186

§ 371 Date: Jun. 24, 2005

(30) Foreign Application Priority Data
Jun. 13, 2002 (DE) 202 09 185.6

(51) Int. Cl. G06K 7/06; G06K 7/00

(52) U.S. Cl. 235/441; 235/486

(57) ABSTRACT

The invention relates to a contacting unit for a card-shaped support element of electronic components, such as for ISO 7816 chipcards, whereby the unit includes a housing in the form of a plug-in card with a base plate and a cover plate which is congruent in the transverse direction, a slot-like plug-in port between the base plate and the cover plate including an opening on a face of the housing for accepting the electronic component, a plug connector strip on a face of the housing, a circuit board arranged in the housing parallel to the plug-in port, the circuit board electronically connected to the plug connector strip and including on its surface a contact field for contacting the electronic component, and whereby the base plate includes a lower-lip type projection located in an area proximate to the plug-in port in direction of insertion of the electronic component.

The invention relates to a contacting unit for a card-shaped carrier element for electronic components, especially for ISO 7816 chip cards, comprising a plug-in card-shaped housing that is equipped with a base plate and with a cover plate that is congruent in the transverse direction, between which is a slot-type plug-in port that opens onto an end face of the housing and is designed to accommodate the chip card is incorporated, and which is equipped on the end face opposite this end face with a plug connector strip, especially a standard PCMCIA connector, and is provided with a printed circuit board arranged parallel to the plug-in port in the housing, which is electrically connected to the plug connector strip and is equipped on its upper surface with a contact field for contacting with the chip card.

Chip card readers of this type are described, for example, in the German utility model DE 298 11 425 U1. They are designed to be plugged in via the plug connector strip, especially a standard PCMCIA connector, to data processing systems, such as notebooks, where they are used to process data or perform applications, such as initiating access authentication to data networks, executing home banking functions or for memory expansion, telephone use and so on. A further use for chip card readers of this type is as a common interface in connection with digital television. For all notebook applications, a short version of reading devices, specifically the PCMCIA Type II, is used, which can be completely flush-mounted in the plug-in slot of the notebook, without any protruding parts that would hamper mobility and handling when the device is inserted. In contrast, for example, with digital and/or pay-TV applications in so-called set top boxes an elongated version of these reading devices is used, in which the rear portion of the housing, in other words on the end face that is opposite the plug connector strip, is equipped with an extension that serves both as a guide for the chip card to be inserted and to facilitate handling of the reading device. The extended section represents a kind of protruding guide for the chip card and mechanically stabilizes the chip card reader for the high-stress operating requirements of the consumer market. The use of this type of reading device with the extension that protrudes from the computer's module mounting slot is out of the question, for example, with notebooks, as there the danger exists that during mobile operation secure contacting will be impaired and transport problems will arise.

One disadvantage of previously known embodiments of contacting units of the type initially described is that they provide insufficient guidance for the chip card during plug-in and/or removal of the chip card from a contacting unit, which can occasionally cause the chip card to become damaged and/or incorrectly contacted during plug-in or removal. Furthermore, the removal of contacting units of this type from a PCMCIA slot, especially, a deep-lying PCMCIA slot designed for use in digital and/or pay-TV applications, is made more difficult.

In view of this state of the art, the object of the invention is to improve a contacting unit of the type initially described in such a way that a secure, especially a damage-free insertion of a chip card into the contacting unit, and an improved removal of the contacting unit from a PCMCIA slot, especially a deep-lying PCMCIA slot designed for use in the field of digital and/or pay-TV applications, are enabled.

The object is attained pursuant to the invention with a contacting unit of the type initially described, which represents a short version without the housing extension, such that only the base plate is extended by a lower-lip-type, flat projection that extends in an area that lies in front of the opening to the plug-in slot in the direction of insertion of the chip card.

The flat, lower-lip-type projection of the base plate assumes the vertical insertion of the chip card into the contacting unit, thus ensuring that the chip card can be plugged in securely and without damage into the contacting unit. Furthermore, with the projection the contacting unit can be removed more easily from a corresponding PCMCIA slot.

In one advantageous embodiment of the invention, the width of the projection crosswise to the housing is equal to or less than the width of the base plate, with the projection preferably being identical in width to or narrower than the PCMCIA and/or the ISO 7816 standard, making the width of the projection less than or equal to 54.00 mm.

Advantageously, the projection is equipped with at least one release aid, which facilitates improved handling of the contacting unit during removal from a PCMCIA slot. In a preferred embodiment of the invention, the release aid is a cam incorporated on the side of the projection, which preferably is formed onto the side of the projection.

In a further advantageous embodiment of the invention, the projection is made of plastic and/or metal.

In order to allow for the need to provide, based upon the area of application, compact reading devices for notebooks and other types of mobile assemblies, while using the long version with the expanded area for stationary applications, for example in digital and/or pay-TV applications, overcoming the substantial obstacles to fulfilling these requirements in the production of contacting units caused by the different production methods and machines that must be used for the different devices, and complicated further by the entire logistics and warehousing system, in a further advantageous embodiment of the invention it is proposed that the flat, lower-lip-like projection be connected to the base plate via a predetermined breaking line. Advantageously, both a short version and a long version of the contacting unit can thus be produced using one manufacturing process. By combining the known short version of the chip card reading device with a projection that can be removed if desired along the predetermined breaking line, and whose shape is based upon its intended application, in other words lower-lip-like or U-shaped or box-shaped, the possibility is created of using a single manufacturing process to produce either the short version (for notebook applications) or the extended version (for digital TV in set top boxes), simply by applying the option of separating the extended area (for notebook applications) or not (for digital TV).

In a further advantageous embodiment of the invention, designing the projection to be U-shaped, i.e. with side arms, can contribute to improving the guidance of the chip card. For certain applications an upper covering may also be provided to the otherwise open U-shaped projection.

Preferably the base plate is connected to the cover plate in the area of the plug connector strip, which can be realized, for example, via weld joints, ultrasonic welding, adhesives, or screws. In this, the plug-in slot is preferably open on both sides all the way through across its entire length in the direction of insertion of the chip card, and the base plate is connected to the cover plate only in the area of the plug connector strip in such a way as to create prestressing between the base plate and the cover plate. In this manner, when the chip card is inserted a slight tilting motion is produced between the base plate and the cover plate, pressing against the restoring force. This design offers both in the short version and in the long version the advantage that the chip card is held in the reading device via a clamping force once it is inserted into the plug-in slot, resulting in a high degree of dimensional stability of the contacting unit and the compensation of production-related tolerances. In the previously known long versions of contacting units this advantageous measure is not possible. According to a further embodiment of the invention, it can be advantageous to connect the projection to the base plate via one or more predetermined breaking points. It can also be expedient for the expansion area formed by the projection to be comprised of partial segments that can be removed depending upon shaping.

According to a further embodiment of the invention, the projection and/or the lateral guide supports are provided with openings and/or notch elements, which can also be provided in order to enable a supplementary or subsequent incorporation of additional electrical modules in the long version, wherein an electrical connection to the printed circuit board is provided. Such modules can contain memory expansions, adapters for smaller memory cards (e.g. SIM cards, multimedia cards, compact flash cards, smart media card, etc.), fax/modem, ISDN, ADSL or LWL transmission and interconnection options for input devices, e.g. a keyboard or biometric input devices.

Further details, characterizing features and advantages of the object of the invention are to be found in the following description of the attached drawings, in which various embodiments of a contacting unit pursuant to the invention are schematically illustrated.

The drawings show:

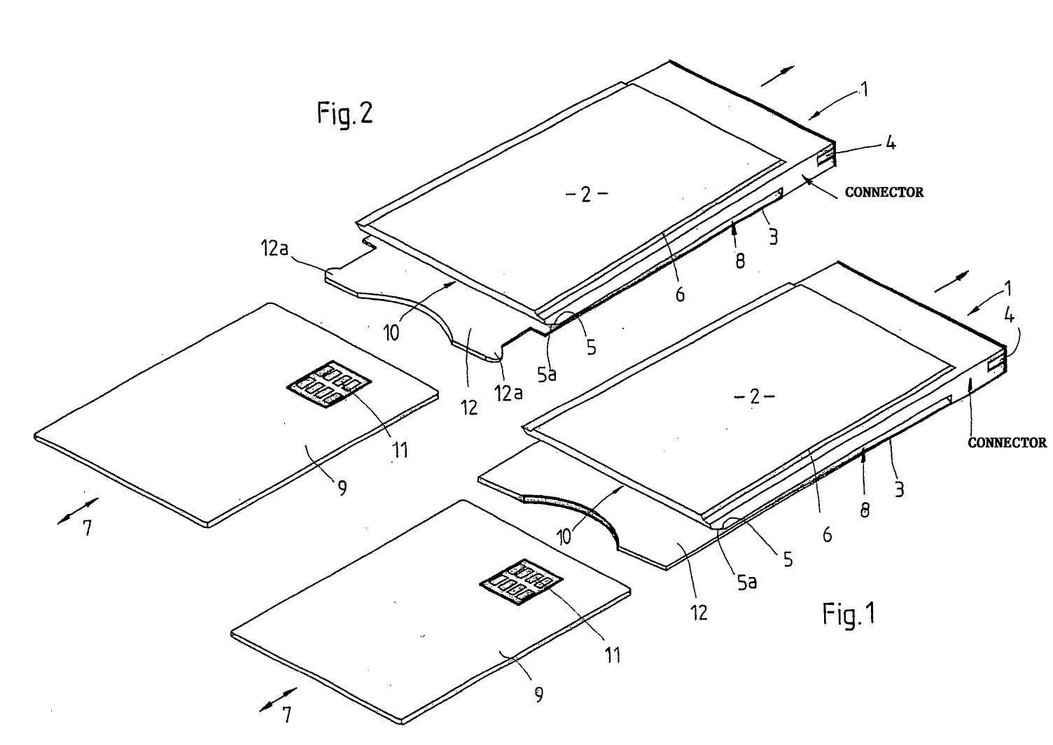

FIG. 1 a perspective illustration of a contacting unit as specified in the invention; [0017 FIG. 2 another perspective illustration of a contacting unit as specified in the invention;

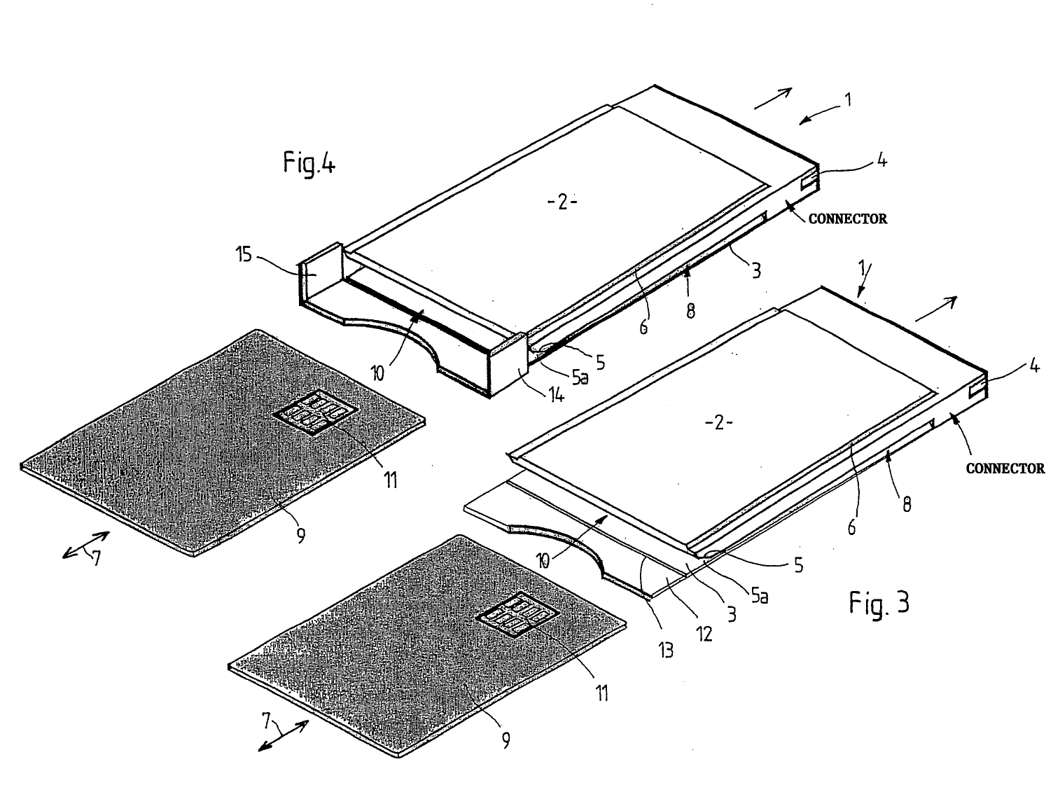

FIG. 3 a further perspective illustration of a contacting unit as specified in the invention, in the long version;

FIG. 4 a perspective illustration of a modified contacting unit with a U-shaped projection;

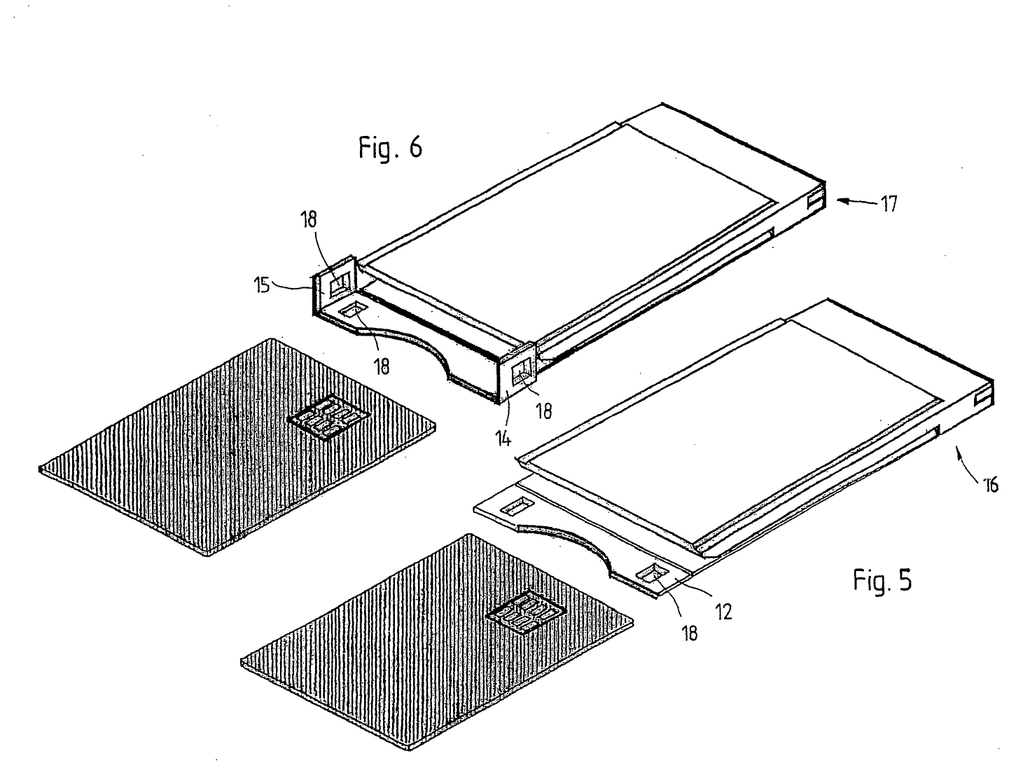

FIG. 5 a modified embodiment of the long version of a contacting unit in a perspective illustration;

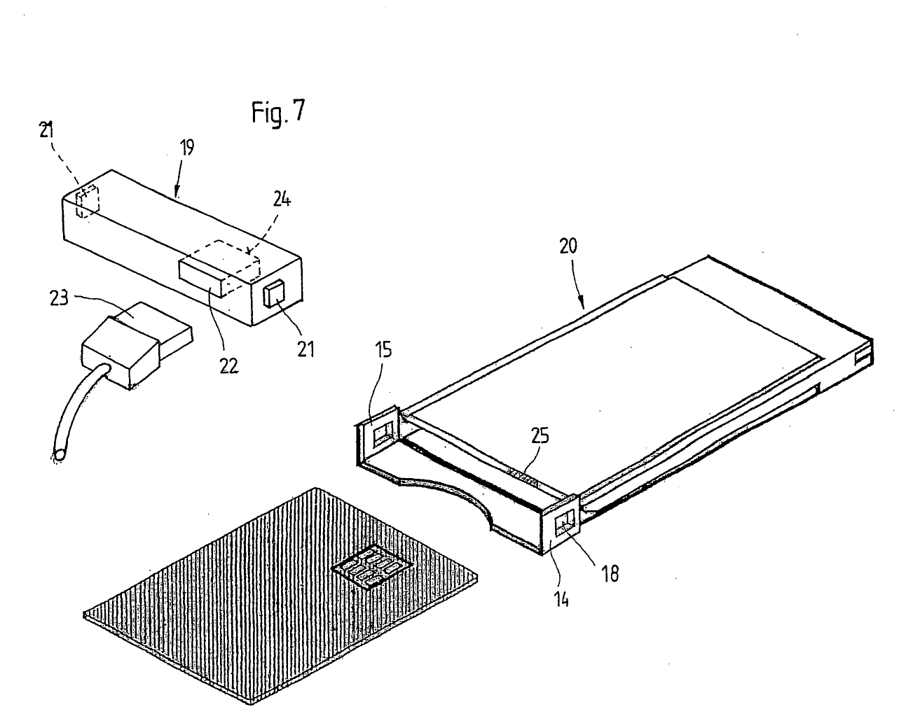

FIG. 6 a perspective illustration of a modified embodiment and

FIG. 7 a perspective illustration of a supplementary electrical module, which can be used in a correspondingly prepared long version of the contacting unit.

The exemplary embodiments of the invention illustrated in FIG. 1 and FIG. 2 show a contacting unit 1 designed as a chip card reader, which is intended to be contacted via a standard PCMCIA interface with a set top box for digital television (not shown here). The contacting unit 1 is comprised of a double-walled outer housing 2 with a base plate 3, a PCMCIA conductor landing in the form of a plug connector strip 4 with 68 poles on the front end in the direction of insertion into the set top box as indicated by the arrow, with an upper and a lower plug-in guide 5, 5a on the opposite end for the insertion of an ISO 7816 chip card 9, and a cover plate 6 that extends parallel to the base plate 3 and spaced from it, which is rigidly connected to the base plate 3 in the area of the plug connector strip 4 (see arrow). Inside the housing 2, a printed circuit board, not visible in the drawing, is arranged parallel to and spaced from the base plate in such a manner that between the two a plug-in slot 8 for the ISO 7816 chip card 9 is formed, wherein said card can be inserted through a plug-in slot 10 that extends between the plug-in guides 5, 5a into the contacting unit 1. The chip card 9 can be inserted into the contacting unit 1 in the direction of the double arrow 7 as indicated in FIG. 1 and FIG. 2 and can be removed again, with contacting occurring via the chip field 11 of the chip card 9 that is positioned on the surface and an inner contact field (not shown) on the underside of the printed circuit board, said contacting enabling the processing of the chip card 9 when the contacting unit 1 is placed in the plug-in slot in the set top box and is connected with its PCMCIA interface via the plug connector strip 4.

As is apparent from the drawing the plug-in slot 8 is open on both sides over its entire length in the direction of insertion of the chip card, and the base plate 3 is connected to the cover plate 6 only in the area of the plug connector strip (area of connection indicated by the arrow). Furthermore, the connection is designed such that prestress is created between the base plate 3 and the cover plate 6, which causes the plug-in slot 8 to narrow toward the plug-in slot 10 when the chip card 9 is not inserted. When the chip card 9 is inserted into the plug-in slot 8, it forces the cover plate 6 to tilt slightly upward against the prestressing force, producing a clamping function for the chip card 9.

The base plate 3 of the contacting unit 1 is extended by a flat, lower-lip-like projection 12, which extends in an area that lies in front of the opening to the plug-in slot 8 in the direction of insertion of the chip card 9. The width of the projection 12 crosswise to the housing 2 is equal to (FIG. 1) or narrower than (FIG. 2) the width of the base plate 3. The flat, lower-lip-like projection 12 of the base plate 3 thus forms an extended area in front of the opening to the plug-in slot 8, which assumes the vertical insertion of the chip card 9 into the plug-in slot 8, thus enabling a secure and, especially for the chip card 9, damage-free insertion of the chip card 9. Furthermore, with the projection 12 a facilitated and improved removal of the contacting unit 1 from a deep-lying PCMCIA slot, especially one that is customarily used with set top boxes for digital television, is enabled. To further improve upon the handling of the contacting unit 1, the projection 12 of the contacting unit 1 as shown in FIG. 2 is equipped at its outermost end with two laterally arranged cam-type recesses which serve as a release aid 12a for the contacting unit 1 from a set top box for digital television.

The exemplary embodiment of the invention depicted in FIG. 3 shows a contacting unit 1 designed as a chip card reader, which is designed to be contacted via a standard PCMCIA interface with a set top box for digital television (not shown). The contacting unit 1 is comprised of a double-walled outer housing 2 with a base plate 3, a PCMCIA conductor landing in the form of a plug connector strip 4 with 68 poles on the front end based upon the direction of insertion into the set top box as indicated by the arrow, with an upper and a lower plug-in guide 5, 5a on the opposite end for the insertion of an ISO 7816 chip card 9 and a cover plate 6 that extends parallel to and spaced from the base plate 3, which is rigidly connected to the base plate 3 in the area of the plug connector strip 4 (see arrow). Inside the housing 2, a printed circuit board, not visible in the drawing, is arranged parallel to and spaced from the base plate in such a manner that between the two a plug-in slot 8 for the ISO 7816 chip card 9 is formed, which can be inserted through a plug-in slot 10 that extends between the plug-in guides 5, 5a into the contacting unit 1. The chip card 9 can be inserted into the contacting unit 1 in the direction of the double arrow 7 as indicated in FIG. 3 and can be removed again, with contacting occurring via the chip field 11 of the chip card 9 that is positioned on the surface and an inner contact field (not shown) on the underside of the printed circuit board, which enables processing of the chip card 9 when the contacting unit 1 is placed in the plug-in slot in the set top box and is connected with its PCMCIA interface via the plug connector strip 4.

As is apparent from the drawing the plug-in slot 8 is open on both sides across its entire length in the direction of insertion of the chip card, and the base plate 3 is connected to the cover plate 6 only in the area of the plug connector strip (area of connection indicated by the arrow). Furthermore, the connection is designed such that prestress is created between the base plate 3 and the cover plate 6, which causes the plug-in slot 8 to narrow toward the plug-in slot 10 when the chip card 9 is not inserted. When the chip card 9 is inserted into the plug-in slot 8, it forces the cover plate 6 to tilt slightly upward against the prestressing force, producing a clamping function for the chip card 9.

The base plate 3 of the contacting unit 1 is extended by a flat, lower-lip-like projection 12, which is connected to the base plate 3 along a predetermined breaking line 13. It is apparent that with this measure a single manufacturing process can be used to produce both a short version of the contacting unit and a long version of the contacting unit 1, in that either the projection 12 is broken off along the predetermined breaking line 13 to produce a short version, or is retained to produce a long version. In addition, in order to improve the guidance for the chip card 9, as shown in FIG. 4 of the drawings a U-shaped recess can be formed in the projection by providing the projection 12 with lateral guide supports 14, 15. It is noted that the lateral guide supports 14, 15 are connected only to the projection 12, and can be removed with the projection when it is broken off in order to produce the short version.

The description makes it clear that the illustrated housing design offers the option of converting a chip card reader that has been produced in the extended version, such as is used for digital television for set top boxes, etc., by removing the extended area, the projection 12, if necessary along with the lateral guide supports 14, 15, to create a short version, which can be used especially for notebook applications.

The embodiment of a chip card reader 16 or 17 illustrated in FIG. 5 and 6 differs from that described above in FIG. 1 and 2 in that the projection 12 and/or the lateral guide supports 14, 15 are provided with openings 18 in which latching elements can become engaged, which can be provided to enable a supplementary incorporation of additional electrical modules in the long version.

A module 19 of this type is schematically illustrated in perspective in FIG. 7. The dimensions of the essentially prismatic module 19 correspond to the open inner space of the projection 12 with lateral guide supports 14, 15, and the module is provided on its sides with latching projections 21. The module 19 bears a socket component 22 for the connection of a plug 23, and is equipped at its front side with a contact surface 24 that interacts with a corresponding contact surface 25 of the associated chip card reader 20 when the module 19 is inserted and is engaged with the openings 18 in the lateral guide supports 14, 15.

The exemplary embodiments shown in the drawings serve only to elucidate the invention and are not intended to limit its scope.

### LEGEND

1 Contacting Unit
2 Outer Housing
3 Base Plate
4 Plug connector strip
5 Plug-In Guide
5a Plug-In Guide
6 Cover Plate
7 Double Arrow
8 Insertion Slot
9 Chip Card
10 Insertion Slot
11 Chip Field
12 Projection
12a Release Aid
13 Predetermined Breaking Line
14 Guide Support
15 Guide Support
16 Chip Card Reader
17 Chip Card Reader
18 Opening
19 Module
20 Chip Card Reader
21 Latching Projection
22 Socket Component
23 Plug
24 Contact Surface
25 Contact Surface

1. Contacting unit for a card-shaped carrier element for electronic components, including a plug-in card-type housing comprising:
a base plate and a cover plate congruent in a transverse direction;
a slot-type plug-in port, between the base plate and the cover plate, that opens onto an end face of the housing accommodate the electronic component;
a plug connector strip on an end face of the housing;
a printed circuit board parallel to the plug-in port in the housing, electrically connected to the plug connector strip, wherein the circuit board includes on its upper surface, a contact field for contacting the electronic component; and
whereby the base plate comprises a flat, lower-lip-type projection, extending in an area that lies in front of We an opening to the plug-in port (8) in direction of insertion of the electronic component.

2. Contacting unit of claim 1, wherein the width of the projection crosswise to the housing is equal to or narrower than the width of the base plate.

3. Contacting unit of claim 1, wherein the projection comprises at least one release aid.

4. Contacting unit of claim 1, wherein the projection is made of plastic and/or metal.

5. Contacting unit of claim 1, wherein the projection is U-shaped.

6. Contacting unit of claim 5, further comprising an upper covering of the U-shaped projection.

7. Contacting unit of claim 1, wherein the base plate is connected to the cover plate in an area of the plug connector strip.

8. Contacting unit of claim 1, wherein the plug-in port is open on both sides, all the way through, across its entire length in direction of insertion of the electronic component, and wherein the base plate is connected to the cover plate in an area of the plug connector strip in such a way that prestress is created between the base plate and the cover plate.

9. Contacting unit of claim 1, wherein the projection is connected to the base plate along a predetermined breaking line.

10. Contacting unit of claim 1, wherein the projection is connected to the base plate at one or more predetermined breaking points.

11. Contacting unit of claim 1, wherein an expansion area formed by the projection comprises partial segments that can be individually separated from the base plate.

12. Contacting unit of claim 14, wherein the projection and/or the lateral guide supports are provided with openings and/or latching elements.

13. Contacting unit of claim 1, comprising a supplementary incorporation of one or more electrical modules, wherein an electrical connection to the printed circuit board is provided.

14. Contacting unit of claim 5, wherein the U-shaped projection comprises lateral guide supports.

15. Contacting unit of claim 1, wherein the electronic component is an ISO 7816 chip card.

16. Contacting unit of claim 1, wherein the slot-type plug-in port is located on the opposite end of the housing from the plug connector strip.

17. Contacting unit of claim 1, wherein the plug connector strip is a standard PCMCIA connector.
